(19) United States
(12) Patent Application Publication
(10) Pub. No.: US 2006/0285955 A1
(43) Pub. Date: Dec. 21, 2006

(54) Battery compartment including a battery lifting mechanism

(75) Inventor: Leland D. Weed, Great Bend, PA (US)

Correspondence Address: QUARLES & BRADY LLP, 411 E. WISCONSIN AVENUE, SUITE 2040, MILWAUKEE, WI, 53202-4497, US

(73) Assignee: The Raymond Corporation

(21) Appl. No.: 11/156,937

(22) Filed: Jun. 20, 2005

(51) Int. Cl. B62D 43/00

(52) U.S. Cl. 414/466

(57) ABSTRACT

A battery compartment for a lift truck includes a plurality of walls defining a volume having an open top for receiving a battery therein. The platform is disposed in the volume and has a support surface for supporting the battery thereon. A lifting mechanism operatively connected to the platform lifts the platform vertically from a lower position toward an upper position and raises the battery supported on the support surface through the open top of the volume.

### CROSS REFERENCES TO RELATED APPLICATIONS

Not Applicable.

### STATEMENT REGARDING FEDERALLY SPONSORED RESEARCH

Not Applicable.

### BACKGROUND OF THE INVENTION

The field of the invention is industrial lift trucks, and particularly the battery compartments for such trucks.

A lift truck can be a battery powered vehicle having an operator compartment with controls that enable the operator to drive the truck and to hoist materials and carry them throughout a factory or warehouse. An upright telescopic mast is often attached to the forward end of the truck and a carriage, or forks, supporting materials can be hoisted by extending the telescopic mast upward.

Electric fork trucks require batteries that must be replaced on a regular basis. The batteries are typically housed in a battery compartment formed in the lift truck body and often require special external equipment for removal. In one type of truck, the batteries are easily accessed from a side of the vehicle and the batteries are removed from the compartment by urging the batteries laterally onto an adjacent support surface. Other lift trucks have a battery compartment with an open top. Removal of the battery from an open top compartment requires lifting the battery vertically.

The open top compartments are typically located beneath the seat of the fork truck operator which simplifies body construction and hides the battery from view during normal use. Removing a battery from an open top compartment, however, typically requires the use of a jib-boom hoist or overhead crane which lifts the battery vertically out of the compartment. The battery is then placed onto a support surface for recharging. Unfortunately, lifting mechanisms, such as a jib-boom hoist or overhead crane, are not always available.

### SUMMARY OF THE INVENTION

The present invention provide a battery compartment for a lift truck. The battery compartment includes a plurality of walls defining a volume having an open top for receiving a battery therein. The platform is disposed in the volume and has a support surface for supporting the battery thereon. A lifting mechanism operatively connected to the platform lifts the platform vertically from a lower position toward an upper position and raises the battery supported on the support surface through the open top of the volume.

A general objective of the present invention is to provide a method and apparatus for changing a battery in a lift truck without the use of external lifting equipment. The objective is accomplished by providing a battery compartment with a platform that is moveable between an upper and lower position. The platform allows the battery to be slid horizontally out of the battery compartment having a volume defined by vertically extending walls.

The foregoing and other objects and advantages of the invention will appear from the following description. In the description, reference is made to the accompanying drawings which form a part hereof, and in which there is shown by way of illustration a preferred embodiment of the invention.

### BRIEF DESCRIPTION OF THE DRAWINGS

FIG. 1 is a rear, side perspective view of a lift truck incorporating the present invention with the lid open and the battery;

FIG. 2 is a front, side perspective view of a lift truck of FIG. 1 with the pan in the upper position;

FIG. 3 is a side perspective view of the lift truck of FIG. 1 with the battery offloaded onto an adjacent support surface;

FIG. 4 is a perspective view of the battery compartment of FIG. 2 with the pan in the lower position;

FIG. 5 is a perspective view of the battery compartment of FIG. 2 with the pan in the upper position;

FIG. 6 is a top, front perspective view of the battery compartment of FIG. 4 with the battery removed;

FIG. 7 is a top, rear perspective view of the battery compartment of FIG. 6;

FIG. 8 is a top plan view of the battery compartment of FIG. 4;

FIG. 9 is an elevation view of the lift track assembly looking in the direction of line 9-9 of FIG. 8;

FIG. 10 is an elevation view of the lift track assembly looking in the direction of line 10-10 of FIG. 8;

FIG. 11 is a section view of the lift track assembly along line 11-11 of FIG. 10;

FIG. 12 is a top, side perspective view of the lifting mechanism of FIG. 7;

FIG. 13 is a detailed view of the lifting mechanism of FIG. 12; and

FIG. 14 is a detailed view of the hydraulic ram of FIG. 13.

### DETAILED DESCRIPTION OF THE PREFERRED EMBODIMENT

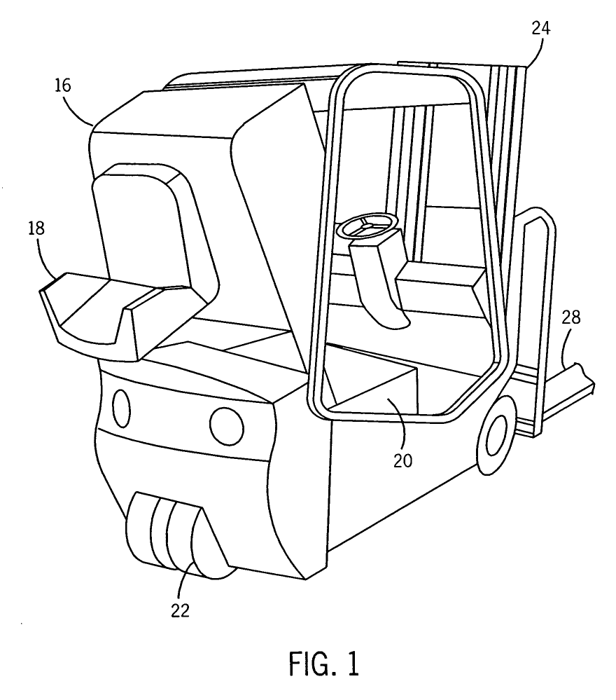

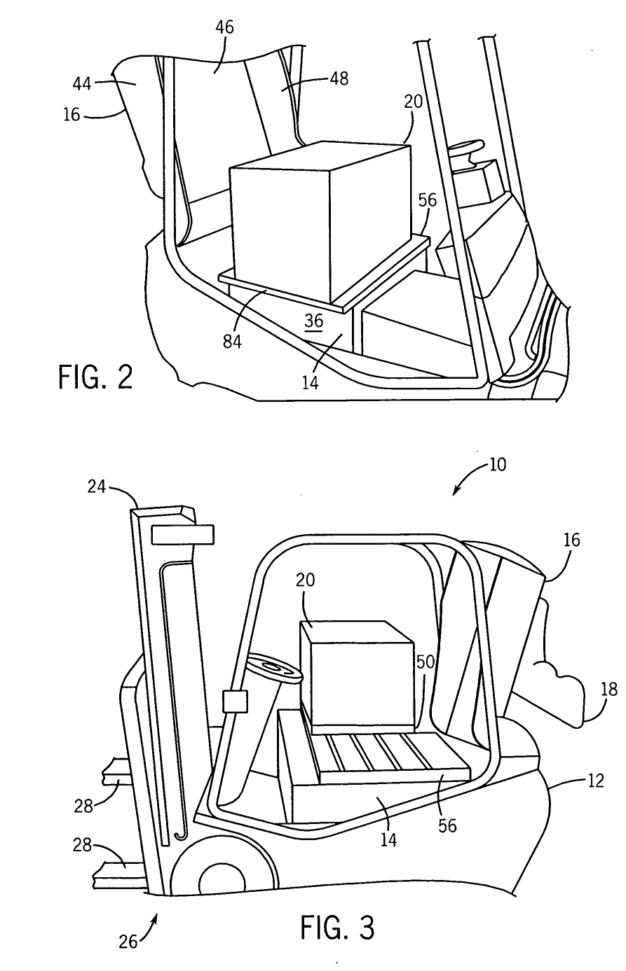

Referring particularly to FIGS. 1-3, a lift truck 10 which employs a preferred embodiment of the invention includes a chassis 12 having a battery compartment 14 covered by a lid 16 supporting an operator seat 18. The lid 16 is hingedly connected to the chassis 12 and pivots upwardly to uncover the battery compartment 14 and a battery 20 disposed therein. The battery 20 supplies power to a number of electronic devices including one or more traction motor drives (not shown) which rotate one or more steerable drive wheels 22 to propel and steer the lift truck 10. A vertical mast 24 connects to the front end 26 of the chassis 12. A pair of horizontally extending forks 28 fixed to the mast 24 are raised and lowered by the mast 24.

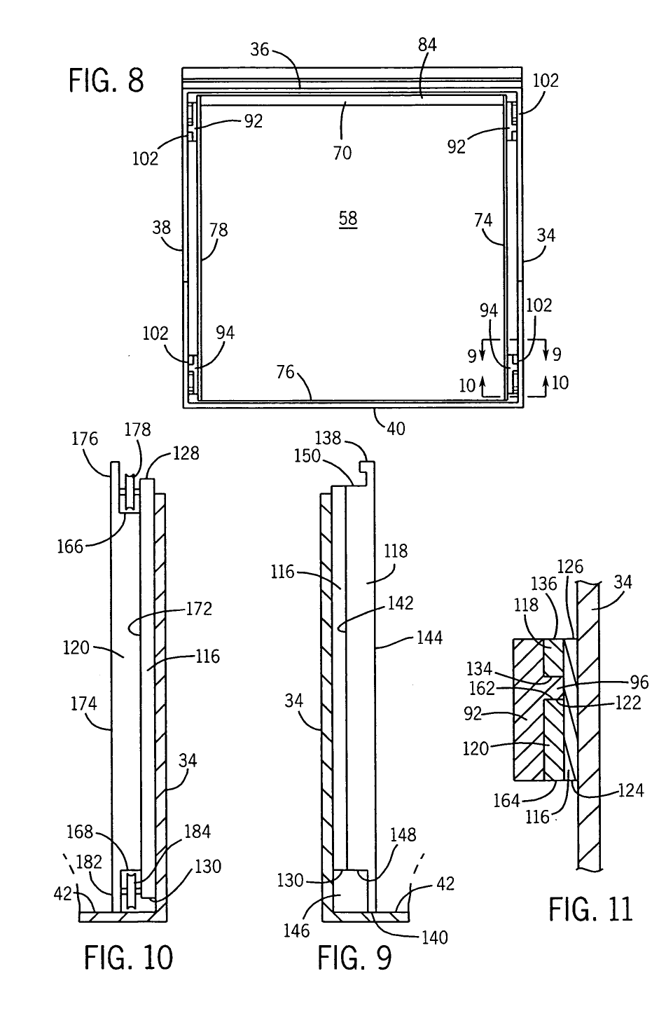

Referring to FIGS. 3-8, and 12, the battery compartment 14 defines a volume 32 surrounded by vertical compartment walls 34, 36, 38, 40, and has an open top covered by the lift truck lid 16. The compartment walls 34, 36, 38, 40 extend vertically upwardly from a battery compartment bottom wall 42. Sidewalls 44, 46, 48 extending downwardly from the lid 16 abut upper edges 52 of the compartment walls 36, 38, 40 to enclose the battery 20 disposed in the battery compartment 14. Of course, the open top can be closed by a lid in addition to, or instead of, the lift truck lid 16 without departing from the scope of the invention.

The battery 20 is raised and lowered in the battery compartment 14 by a lifting mechanism 30 that simplifies loading and unloading the battery into and out of the battery compartment. The lifting mechanism 30 includes a rectangular pan 56 having lift brackets 92, 94 that engage lift track assemblies 102. The lift brackets 92, 94 are operatively connected to a dual hydraulic actuator 198 that is actuated to raise the battery 20 above the battery compartment sidewall 36 for easy unloading of the battery 20 onto an adjacent support surface 50.

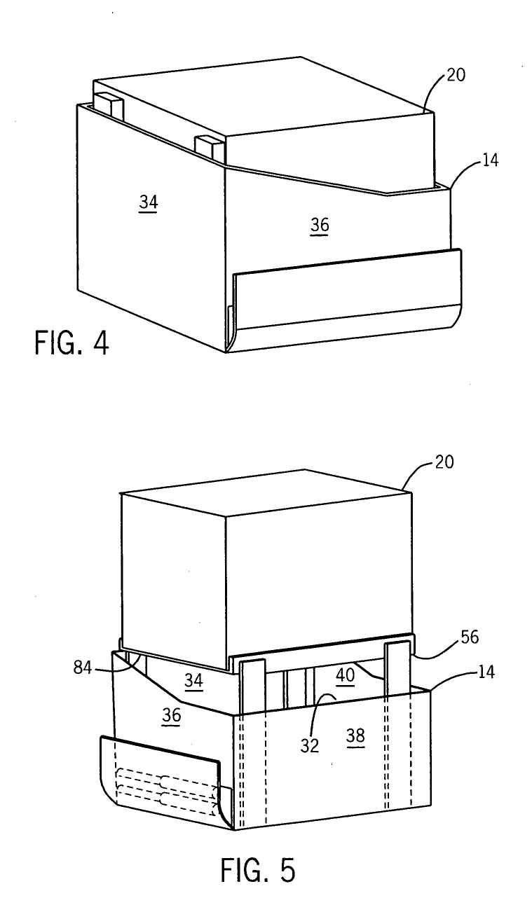

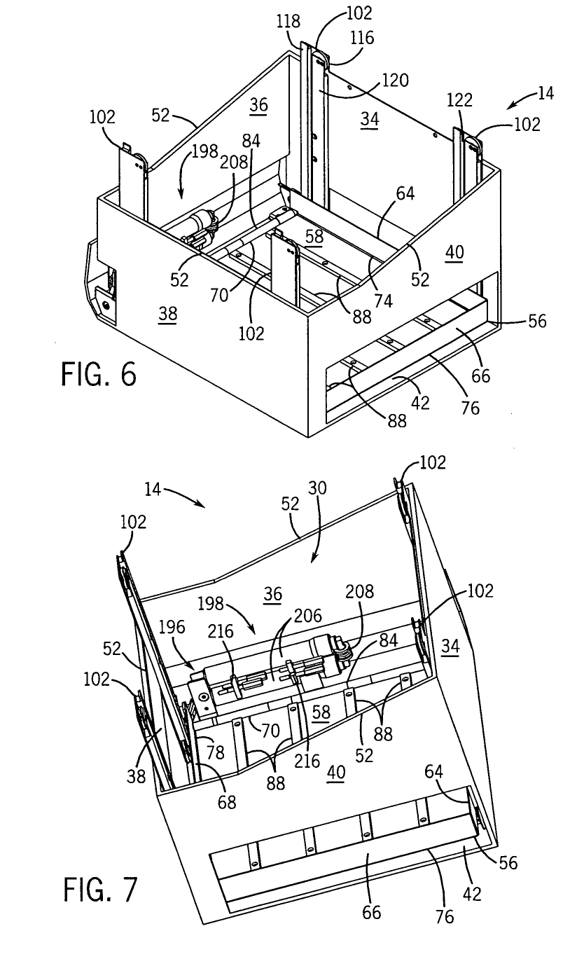

The battery 20 is supported on the rectangular pan 56, or platform, mounted in the battery compartment 14 for vertical movement between an upper position (shown in FIG. 5) and a lower position (shown in FIGS. 4 and 6). In the lower position, the pan 56 is disposed below the upper edges 52 of the compartment walls 34, 36, 38, 40, and the lid 16 can be closed over the compartment top with the battery 20 supported on the pan 56. In the upper position, the pan 56 is disposed above one of the side compartment walls 36 which allows the battery 20 to slide transversely off of the pan 56 onto the adjacent support surface 50 or from the support surface transversely onto the pan 56.

The pan 56 is preferably formed from steel, or other corrosive resistant material, and includes a bottom wall 58 having three vertical extending walls 64, 66, 68. Front and rear vertically extending walls 68, 64 extend upwardly from front and rear edges 78, 74 of the bottom wall 58 to prevent the battery 20 from sliding off of the pan 56 in the forward and rearward directions. The side wall 66 extending vertically from one side edge 76 of the bottom wall 58 prevents the battery 20 from sliding transversely past the one side edge 76 of the pan bottom wall 58. The front and rear vertical walls 68, 64 extend past the other side edge 70 of the bottom wall 58 and rotatably support a roller shaft (not shown) parallel to the other bottom wall side edge 70.

The roller shaft is preferably formed from steel and rotatably mounts a roller 84 that supports the battery 20 as it is loaded onto the pan 56 and unloaded from the pan 56. The roller 84 has an outer diameter that extends above the battery bottom wall 58, such that the roller 84 supports the battery 20 as the battery 20 transitions onto and off of the pan 56. Preferably, the roller 84 is formed from an aluminum-bronze alloy that resists corrosion caused by fluid leaking from the battery 20.

Slide strips 88 formed from a low friction material, such as Ultra High Molecular Weight (UHMW) plastic, are fixed to the battery bottom wall 58 using methods known in the art, such as adhesives, mechanical fasteners, and the like. The elongated, rectangular slide strips 88 extend transversely between the side edges 70, 76 of the bottom wall 58 and allow the battery 20 to slide transversely across the battery bottom wall 58 when unloading and loading the battery 20 onto the pan 56. Upper surfaces of the slide strips 88 form a support surface that support the battery 20 on the pan 54. Although slide strips 88 are preferred, the slide strips 88 can be omitted resulting in the upper surface of the pan bottom wall 58 forming the support surface, or other means for reducing friction can be provided, such as rollers rotatably mounted above the pan bottom wall 58, and the like, without departing from the scope of the invention.

A pair of front lift brackets 92 and a pair of rear lift brackets 94 fixed to the pan 56 are operatively connected to cables 104, 106, 108, 110 which vertically move the pan 56 in the battery compartment 14. The pair of front lift brackets 92 are fixed to the pan bottom wall 58 and front wall 68 along the front edge 78 of the bottom wall 58 proximal each of the side edges 70, 76 of the bottom wall 58. The pair of rear lift brackets 94 are fixed to the pan bottom wall 58 and rear wall 64 along the rear edge 74 of the bottom wall 58 proximal each of the side edges 70, 76 of the bottom wall 58.

Each lift bracket 92, 94 is fixed to the bottom wall 58 using methods known in the art, such as welding, mechanical fasteners, and the like. A sliding block 96 extending outwardly from each lift bracket 92, 94 slidably engages a lift track assembly 102 that guides the adjacent lift bracket 92, 94 between the upper and lower positions. The cable 104, 106, 108, 110 connected to each sliding block 96, such as by a bolt, lifts and lowers the lift bracket 92, 94, and thus the pan 56, between the upper and lower positions.

Referring now to FIGS. 6-11, each lift track assembly 102 is fixed in the battery compartment 14 proximal the compartment walls 34, 38. Preferably, each lift track assembly 102 is bolted to one of the compartment walls 34, 38 adjacent the respective lift bracket 92, 94. Of course, other methods known in the art can be used to fix the lift track assembly 102 in the battery compartment 14, such as welding, riveting, and the like, without departing from the scope of the invention.

Each lift track assembly 102 includes a rectangular base plate 116 fixed to one of the compartment walls 34, 38. A guide bar 118 and pulley guard 120 fixed to the base plate 116 define a guide slot 122 therebetween. The sliding block 96 extending from the adjacent lift bracket 92, 94 is received in the slot 122 which guides the respective bracket 92, 94, and thus the pan 56, as the pan 56 moves vertically between the upper and lower positions.

The base plate 116 provides a base for fixing the guide bar 118 and pulley guard 120 relative to each other to define the guide slot 122. Advantageously, the base plate 116 simplifies installation by allowing the lift track assembly 102 to be assembled prior to installation into the battery compartment 14. The base plate 116 includes a rear edge 124 and front edge 126 joined by upper and lower edges 128, 130. Preferably, the lower edge 130 of the base plate 116 is spaced from the bottom wall 42 of the battery compartment 14.

The rectangular guide bar 118 is fixed to the base plate 116 using methods known in the art, such as welding, mechanical fasteners, and the like, and has a rear edge 134 and a front edge 136 joined by upper and lower ends 138, 140 and inner and outer surfaces 142, 144. The front edge 136 of the guide bar 118 is aligned with the front edge 126 of the base plate 116, and the inner surface 142 of the guide bar 118 abuts the base plate 116. The lower end 140 of the guide bar 118 abuts the bottom wall 42 of the battery compartment 14 and extends past the lower edge 130 of the base plate 116 to space the base plate 116 from the bottom wall 42 of the battery compartment 14 to form a cable passageway 146. Preferably, the lower end 140 of the guide bar 118 includes a notch 148 which extends the cable passageway 146 inwardly away from the adjacent battery compartment wall 34, 38 past the inner surface 142 of the guide bar 118. The upper end 138 of the guide bar 118 extends upwardly past the base plate 116, and also includes a notch 150 formed in the inner surface 142 of the guide bar 118.

The pulley guard 120 is fixed to the base plate 116 using methods known in the art, such as welding, mechanical fasteners, and the like, and has a front edge 162 and a rear edge 164 joined by upper and lower ends 166, 168 and inner and outer surfaces 172, 174. The rear edge 164 of the pulley guard 120 is aligned with the rear edge 124 of the base plate 116, and the inner surface 172 of the pulley guard 120 abuts the base plate 116. The guide slot 122 is defined between the rear edge 134 of the guide bar 118 and the front edge 162 of the pulley guard 120.

An upper pulley cover 176 extending upwardly from the upper end 166 of the pulley guard 120 is spaced from the base plate 116 for receiving an upper pulley 178 therebetween. Likewise, a lower pulley cover 182 extending downwardly from the lower end 168 of the pulley guard 120 is spaced from the base plate 116 for receiving a lower pulley 184 therebetween. Each of the upper and lower pulleys 178, 184 guides one of the cables 104, 106, 108, 110 fixed to the adjacent lift bracket 92, 94 slidably engaging the lift track assembly 102.

The lower pulley 184 is rotatably mounted between the lower pulley cover 182 and base plate 116, and guides the cable 104, 106, 108, 110 extending through the cable passageway 146 upwardly towards the upper pulley 178. The upper pulley 178 is rotatably mounted between the upper pulley cover 176 and base plate 116, and guides the cable 104, 106, 108, 110 extending from the lower pulley 184 over the upper end 166 of the pulley guard 120 and down the guide slot 122 towards the lift bracket 92, 94.

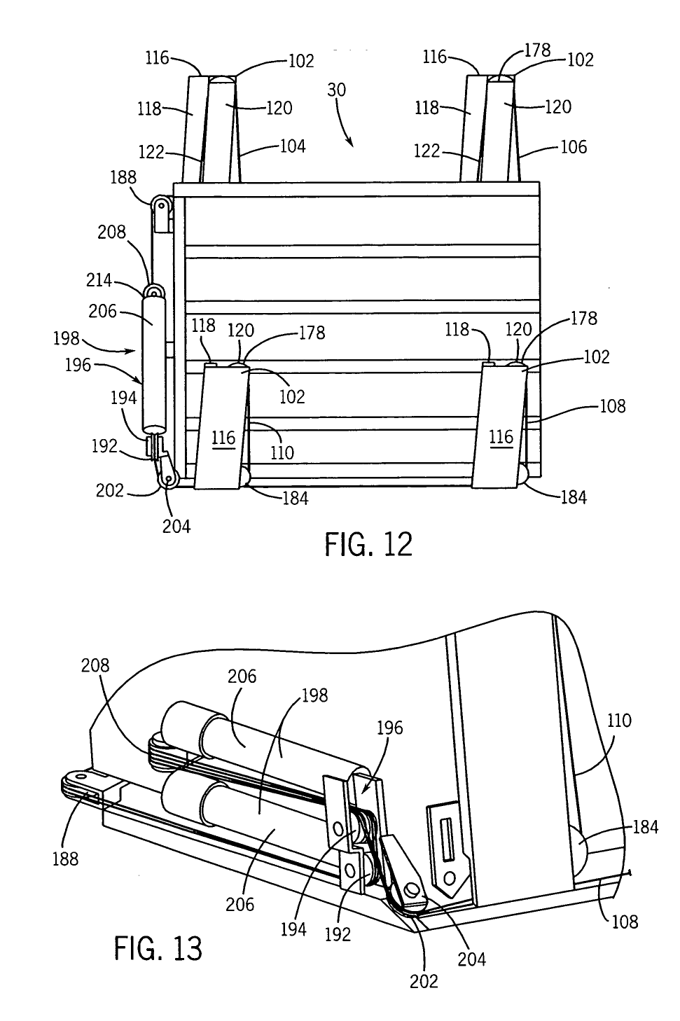

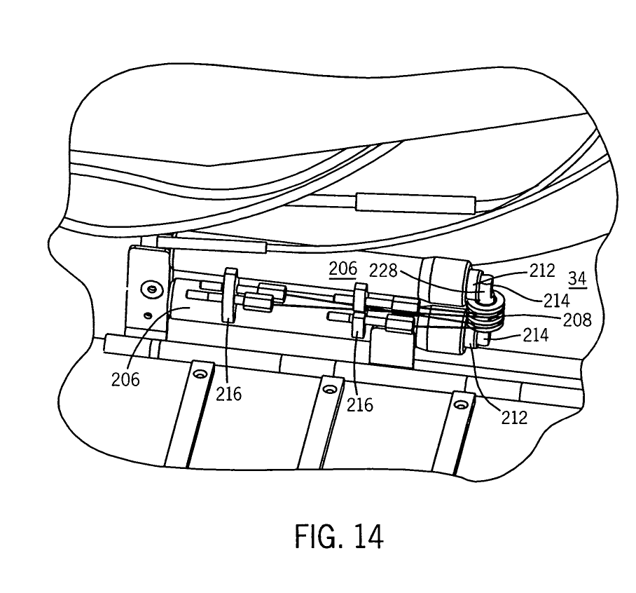

Referring to FIGS. 12-14, the cables 104, 106, 108, 110 guided by the pulley 178, 184 of each lift track assembly 102 simultaneously lift and lower the lift brackets 92, 94, and thus the pan 56, between the upper and lower positions. Each cable 104, 106 having one end fixed to the front lift brackets 92 is routed from the respective lower pulley 184 via a first dual pulley 188 rotatably mounted to the battery compartment bottom wall 42 to a second dual pulley 192 which guides the pair of cables 104, 106 toward a quad sheave centering pulley 194 rotatably mounted at an end 196 of the dual hydraulic actuator 198. Likewise, each cable 108, 110 having one end fixed to the rear lift brackets 94 are routed via a third dual pulley 202 rotatably mounted on an angle bracket 204 which guides the cables 108, 110 directly toward the quad sheave centering pulley 194. The quad sheave centering pulley 194 guides all four cables 104, 106, 108, 110 between a pair of parallel cylinders 206 of the dual hydraulic actuator 198 toward a quad sheave ram pulley 208. The quad sheave ram pulley 208 guides the cables 104, 106, 108, 110 around an exposed end 212 of extendible rams 214 extending from the cylinders 206 to anchors 216 fixed to the cylinders 206.

The dual hydraulic actuator 198 includes the pair of parallel cylinders 206 fixed adjacent the rear wall 34 of the battery compartment 14 and relative to the battery compartment bottom wall 42 by a pair of brackets 222. Each cylinder 206 includes one of the extendible rams 214 which are moveable between an extended position and a retracted position. Each extendable ram 214 includes an inner end (not shown) received in the respective cylinder 206 and the outer exposed end 212. Although a dual hydraulic actuator 198 is preferred, other actuators, such as a single hydraulic actuator, a motorized or manual cable reel, a pneumatic actuator, and the like can be used without departing from the scope of the invention.

The outer ends 212 of each cylinder 206 are joined by a quad sheave ram pulley shaft 228 that rotatably mounts the quad sheave ram pulley 208. The dual hydraulic actuator 198 is in fluid communication, such as by hydraulic hoses, with a source of hydraulic fluid that is controlled by the operator to selectively move the extendable rams 214 between the extended and retracted positions. Extension of the extendable rams 214 toward the extended position pulls the cables 104, 106, 108, 110 through the respective pulleys 178, 184, 188, 194, 202, 208 to lift the pan 56 and raise the battery 20 out of the battery compartment 14, such that the battery 20 can be urged laterally onto or off of an adjacent support surface.

In use, referring to FIGS. 1-14, the pan 56 is raised to the upper position by extending the extendable rams 214 toward the extended position. As the rams 214 extend toward the extended position, the cables 104, 106, 108, 110 are pulled through the respective pulleys 178, 184, 188, 194, 202, 208 to lift the pan 56 toward the upper position. At the upper position, the outer diameter of the roller 84 extends above the side compartment wall 36.

The battery 20 is slid onto the pan 56 over the side compartment wall 36 by urging the battery 20 over the roller 84 and onto the slide strips 88. The roller 84 and slide strips 88 minimize friction as the battery 20 is urged onto the pan 56 to reduce the force necessary to place the battery 20 onto the pan 56.

Once the battery 20 is supported by the pan 56 above the volume defined by the vertical compartment walls 34, 36, 38, 40, the rams 214 are retracted toward the retracted position which lets out the cables 104, 106, 108, 110 and lowers the pan 56 toward the lower position. Advantageously, the weight of the battery 20 on the pan 56 maintains tension in the cables 104, 106, 108, 110, as the rams 214 are retracted.

Once the pan 56 is in the lower position and the battery 20 is disposed in the battery compartment volume 32, the lid 16 is closed over the battery compartment 14 to hide the battery 20 from view and protect the battery 20 from damage. The battery 20 is removed by reversing the above steps to offload the battery 20 onto the adjacent supporting surface 50.

While there has been shown and described what are at present considered the preferred embodiments of the invention, it will be obvious to those skilled in the art that various changes and modifications can be made therein without departing from the scope of the invention defined by the appended claims. For example, the lifting mechanism can be a vertical hydraulic cylinder that directly lifts the pan without departing from the scope of the invention.

I claim:

1. A battery compartment for a lift truck, said battery compartment comprising:
a plurality of walls defining a volume having an open top for receiving a battery therein;
a platform disposed in said volume and having a support surface for supporting the battery thereon; and
a lifting mechanism operatively connected to said platform to lift said platform vertically from a lower position toward an upper position and raise the battery supported on said support surface through said open top of said volume.

2. The battery compartment as in claim 1 in which said lifting mechanism includes a hydraulic ram operatively connected to said platform, said hydraulic ram having a first position and a second position, wherein movement between said first position toward said second position raises said platform from said lower position toward said upper position.

3. The battery compartment as in claim 2 in which said hydraulic ram is operatively connected to said platform by a cable.

4. The battery compartment as in claim 2, in which said hydraulic ram is mounted in said volume.

5. The battery compartment as in claim 1, in which said platform is guided by at least one lift track assembly fixed to one of said walls as said platform moves between said upper and lower positions.

6. The battery compartment as in claim 5, in which said lift track assembly includes a vertically extending guide slot that guides said platform between said upper and lower positions.

7. The battery compartment as in claim 5, in which pulleys rotatably mounted to said lift track assembly guide at least one cable operatively connecting said ram to said platform.

8. The battery compartment as in claim 1, including at least one slide strip fixed to said support surface to minimize friction when sliding the battery onto said platform.

9. The battery compartment as in claim 1, in which said platform includes an edge, and a roller rotatably mounted adjacent said edge supports the battery as the battery is loaded onto said platform.

10. The battery compartment as in claim 1, in which said platform is a pan having a bottom wall defined by edges and at least one vertical wall extending upwardly from one of said edges.

11. A lift truck comprising:
a battery compartment having a plurality of walls defining a volume having an open top for receiving a battery therein;
a platform disposed in said volume and having a support surface for supporting the battery thereon; and
a lifting mechanism operatively connected to said platform to lift said platform vertically from a lower position toward an upper position and raise the battery supported on said support surface through said open top of said volume.

12. The lift truck as in claim 11 in which said lifting mechanism includes a hydraulic ram operatively connected to said platform, said hydraulic ram having a first position and a second position, wherein movement between said first position toward said second position raises said platform from said lower position toward said upper position.

13. The lift truck as in claim 12 in which said hydraulic ram is operatively connected to said platform by a cable.

14. The lift truck as in claim 12, in which said hydraulic ram is mounted in said volume.

15. The lift truck as in claim 11, in which said platform is guided by at least one lift track assembly fixed to one of said walls as said platform moves between said upper and lower positions.

16. The lift truck as in claim 15, in which said lift track assembly includes a vertically extending guide slot that guides said platform between said upper and lower positions.

17. The lift truck as in claim 15, in which pulleys rotatably mounted to said lift track assembly guide at least one cable operatively connecting said ram to said platform.

18. The lift truck as in claim 11, including at least one slide strip fixed to said support surface to minimize friction when sliding the battery onto said platform.

19. The lift truck as in claim 11, in which said platform includes an edge, and a roller rotatably mounted adjacent said edge supports the battery as the battery is loaded onto said platform.

20. The lift truck as in claim 11, in which said platform is a pan having a bottom wall defined by edges and at least one vertical wall extending upwardly from one of said edges.

21. A method of loading a battery into a battery compartment of a lift truck; said method comprising:
raising a platform vertically toward an upper position proximal an open top of a volume defined by vertically extending battery compartment walls;
sliding a battery onto a support surface of said platform over at least one of said vertically extending battery compartment walls;
lowering said battery disposed on said platform through said open top toward a lower position in said volume defined by said battery compartment walls.

22. The method as in claim 21, in which raising said platform includes actuating a ram operatively connected to said platform.

23. The method as in claim 21, including guiding said platform between said upper and lower positions.

24. The method as in claim 22, in which guiding said platform includes engaging a sliding block extending outwardly from said platform in a vertical slot adjacent said platform.
